(19) United States
(12) Patent Application Publication
(10) Pub. No.: US 2004/0061260 A1
(43) Pub. Date: Apr. 1, 2004

(54) Device and method for the manufacturing of three-dimensional objects layer-by-layer

(75) Inventor: Martin Heugel, Landsberg-Pitzling (DE)

Correspondence Address: Dike, Bronstein, Roberts & Cushman, Intellectual Property Practice Group, Edwards & Angell, LLP, P.O. Box 9169, Boston, MA, 02209, US

(73) Assignee: EOS GmbH Electro Optical Systems

(21) Appl. No.: 10/675,885

(22) Filed: Sep. 29, 2003

(30) Foreign Application Priority Data
Sep. 30, 2002 (DE) 102 45 617.8

(51) Int. Cl. B29C 35/08; B29C 41/02

(52) U.S. Cl. 264/401; 425/174.4

(57) ABSTRACT

A device and a method for the layer-by-layer generative manufacturing of three-dimensional objects by selective hardening of a previously applied layer by means of laser radiation, wherein a laser (1) contains a switching device (8) for changing the modal composition of the laser radiation. By changing the modal composition of the radiation during the selective hardening of a layer, the focussing features (“focusability”) of the radiation is increased in areas (25), in which high structural accuracy is required. In the remaining areas to be illuminated, the required illumination time is reduced by increasing the intensity of the radiation.

The present invention refers to a device and a method for the manufacture of three-dimensional objects according to the preamble of Patent claim 1 or Patent claim 4.

In generative manufacturing procedures, e.g. selective laser sintering including selective laser melting or stereolithography, three-dimensional objects are manufactured layer-by-layer by applying a building material in layers, and connecting such layers by selective hardening of the sites corresponding to the cross-section of the objects.

A procedure of this type and a device of this type are known, for example, from EP 0 734 842, which describes the selective laser sintering of a powered building material. Therein, a first layer of a powdered material is applied to a carrier that can be lowered, and the sites corresponding to the object are laser-illuminated such that the material sinters at the illuminated sites. Subsequently, the carrier is lowered and a second layer is applied onto the first layer, selectively sintered, and thus connected to the first layer. By proceeding in this fashion, the object is generated layer-by-layer.

Provided a laser beam is used for selective hardening, the structural resolution of the object to be generated is the higher, the smaller the beam focus on the layer to be hardened is. However, the use of a small beam focus causes an increase in illumination time if the layer is extensive. For this reason, for instance EP 0 758 952 proposes to separate the cross-section of an object to be generated during the illumination into a marginal area to be illuminated with a small focus and an inner area to be illuminated with a large focus. As a result, a small beam focus can be selected in the marginal area to achieve a high structural resolution, whereas the selection of a larger beam focus in the inner area speeds up the hardening process of the inner area.

It is suggested in EP 0 758 952 to generate beam focuses of differing diameters by means of a beam optics being arranged external to the laser. However, the range of variation of the focal point diameter is limited in this arrangement since the focussing features (“focusability”) of the radiation depends not only on the optics used but also on the beam quality that is determined by the laser beam source, as characterized by the so-called beam parameter product. As is shown in FIG. 3, the beam parameter product is defined as the product of the beam parameters, radius at the beam waist w and angle of divergence T relative to optical axis O (see FIG. 3). Accordingly, the beam quality is the better, the smaller the product of the radius of the beam waist and the angle of divergence is. The optimal beam quality is attained in the so-called fundamental mode of Gauss, and is determined by the wavelength of the radiation.

It is therefore an object of the present invention to provide a method and a device for layer-by-layer generative manufacturing of three-dimensional objects, in which the beam properties can be adjusted to suit the illumination requirements in the different areas of an object to be generated.

The object is achieved by a device according to claim 1 and a method according to claim 4.

Further developments of the present invention are described in the dependent claims.

Other characteristics and features of the present invention are evident from the description of embodiments with reference to the figures. The figures show:

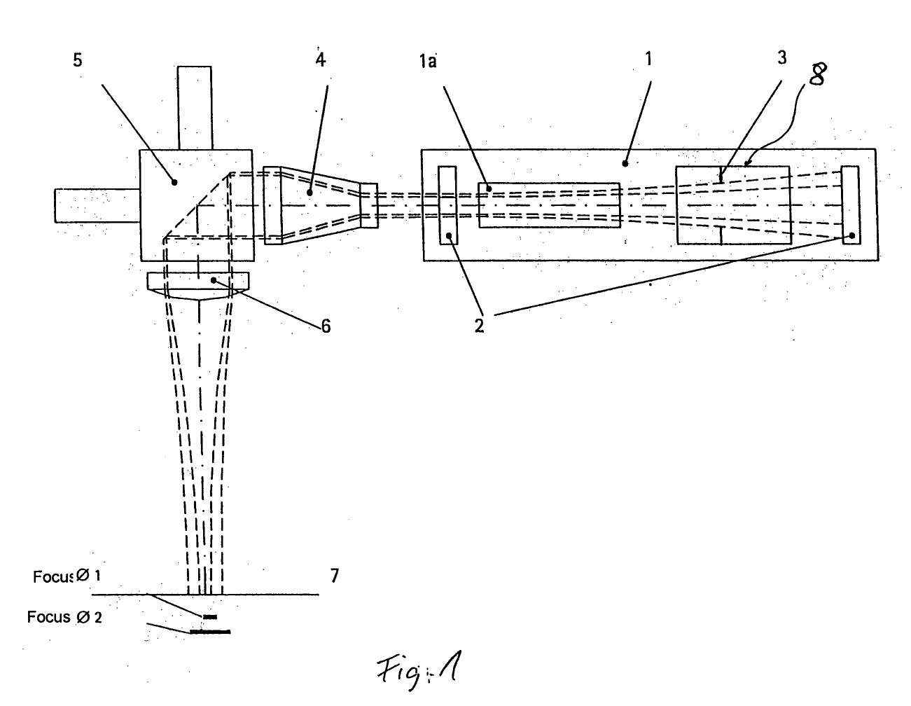

FIG. 1: a schematic illustration of a device according to a first embodiment of the present invention,

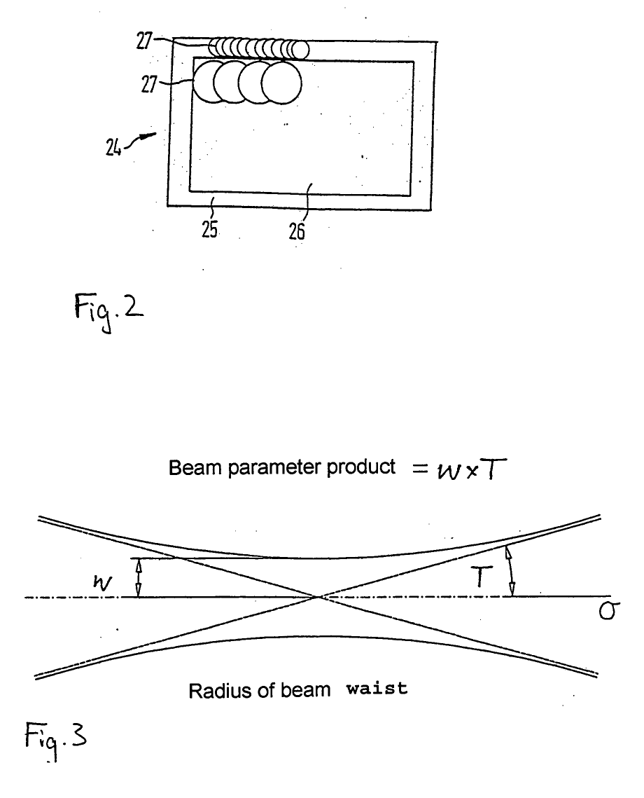

FIG. 2 a schematic illustration of an exemplary cross-section of an object to be generated, and

FIG. 3 a schematic illustration of the beam parameter product.

FIG. 1 shows a device according to a first embodiment of the present invention. Laser 1 shown in FIG. 1 contains a laser-active medium, 1a, and a resonator comprising two mirrors 2. The laser beam emitted by laser 1 is directed by beam deflection unit 5 onto the areas of a layer 7 that need to be hardened. A beam expansion unit 4 is arranged in the path of the beam between laser 1 and beam deflection unit 5. Focussing unit 6 is arranged in the path of the beam between beam deflection unit 5 and the plane of layer 7 that needs to be hardened, said focussing unit 6 being used to focus the beam in the plane of layer 7 that needs to be hardened. Switching device 8 allows for variation of mode aperture 3 inserted into the resonator.

The provision of a small mode aperture leads to TEM modes of a higher order being suppressed in the laser. In this case, to provide maximal beam quality, the radiation ideally oscillates only in the fundamental mode of Gauss, in which the intensity distribution with regard to cross-sections that are perpendicular to the optical axis takes on a Gaussian shape. Accordingly, the beam parameter product attains its radiation wavelength-dependent minimum. If the wavelength is given, the physical optimum in terms of the focussing of the laser by laser-related means is achieved under these conditions. This means that any further influence on the focal point diameter can be provided solely by the suitable design of the downstream optical system in terms of varying the working distance and aperture diameter. In contrast, the use of a mode aperture with a large aperture diameter allows the emission of higher transversal modes of radiation. Under these circumstances, the beam parameter product of the beam is larger. As a consequence, only accordingly larger focal point diameters can be attained with the same design of optical system.

In the device described above, the variation of the mode aperture in laser 1 by means of switching device 8 can be used to change the focussing features of the laser beam. This provides for the optimization of a method of layer-by-layer, generative manufacture of a three-dimensional object by applying laser radiation to the sites in each layer that correspond to the cross-section of the object. A method of this type comprises alternating steps of applying a layer of a building material onto a carrier or a previously applied layer and selective hardening of areas of this layer by means of laser radiation. By varying the diameter of the laser beam at the site, where it impacts the layer, an optimal compromise can be achieved between the illumination time and the structural accuracy in the hardening process, as shall be shown using FIG. 2.

FIG. 2 shows as an example area 24 of a layer, said area 24 needing to be hardened and corresponding to a cross-section of an object to be manufactured. During the hardening process, area 24 is subdivided into a marginal or contour area, 25, and an inner area 26. Within marginal area 25 it is important to be able to resolve fine details. For this reason, it is advantageous to be able to select the laser beam focus in this area as small as possible. Thus, for hardening of marginal area 25, the laser beam is directed onto this area and the switching unit is used to select the small mode aperture 3. As a result, the laser only emits the Gaussian fundamental mode and the laser beam impinging on the layer has a small focal point diameter 1. Without any further changes on focussing unit 6, simply the selection of a small mode aperture 3 leads to the focal point diameter being smaller because the radiation can be focussed better. In order to ensure that sufficient energy is supplied to the material whose marginal area needs to be hardened, the path feed rate of the laser beam can be reduced. This can be done without any major increase in the overall process time since the marginal area usually accounts for a much smaller fraction of the total area than the inner area.

There is a lesser need for fine resolution of details in inner area 26 as compared to marginal area 25. Moreover, the area of inner area 26 usually is much larger than the area of marginal area 25. It is therefore advantageous to select a larger beam focus for inner area 26 than for marginal area 25 in order to keep the hardening time for the inner area as short as possible. For this purpose, without having to make any changes in focussing unit 6, a mode aperture 3 with a larger aperture diameter than was selected for the illumination of marginal area 25 can be selected by switching unit 8. As a result, the radiation contains higher order modes and cannot be focussed as well, but the overall power of the radiation is increased. Since it is desired to provide for short overall illumination times in the illumination of large areas, it is advantageous to work with a less-focussed beam of higher intensity. The beam quality is reduced when a larger mode aperture 3 is employed. However, this is of minor importance in the inner area which is often illuminated with the “hatch” technique. Switching from the smaller to the larger mode aperture and vice versa is facilitated by a rapid switching element in order to provide for a high process rate.

The focussing by means of focussing unit 6 is rendered much simpler by the beam focus being varied by means of mode aperture 3. As a result, the beam focus can be varied simply by changing the mode aperture without a need to have variable focussing optics. The focussing unit is fixed to a previously determined optimal setting (focus setting).

Moreover, the method described above provides for the hardening of the layer to proceed more rapidly. If the beam focus was set solely by means of focussing unit 6, then, as a result, the beam with a smaller focal point diameter would always possess a higher energy density as compared to the beam with a larger focal point diameter. In order to apply uniform amounts of energy to all sites of the layer for the hardening process, the energy density of the beam with a smaller focal point diameter would have to be reduced by reducing the laser energy or the beam with the smaller focal point diameter would have to be moved more rapidly than the beam with the larger focal point diameter. Due to the ratio of areas, though, the objective is just the opposite: the beam with the larger focal point diameter should be moved more rapidly than the beam with the smaller focal point diameter because the area of inner area 26 is larger than the area of marginal area 25.

In contrast, the increase in mode aperture size in the laser in effect increases the radiation power, since the radiation contains additional modes. The use of a mode aperture thus counteracts the reduction of the energy density of the beam by defocussing such that the beam with the larger focal point diameter can be advanced more rapidly and the hardening time is reduced.

The change in mode composition brought about by the selection of various mode apertures can also be done in order to impact or place a desired amount of energy. It may be desirable to illuminate certain spatial areas more strongly, for instance, in order to establish a higher material density.

In a second embodiment, an additional change is made on focussing optics 6 during the hardening process. This provides for more options in the selection of a suitable beam focal point diameter as compared to the first embodiment.

In a further embodiment, the expansion factor of the radiation can be changed also during illumination by means of beam expansion device 4. This provides an additional degree of freedom for setting the focal point diameter.

It is obvious to consider using more than two different mode apertures. Accordingly, it would be possible to select from more than two different beam diameters.

Furthermore, it may be advantageous in certain cases, to generate different higher order mode compositions during the illumination by employing mode apertures which differ in their diameter or geometrical shape.

1. Device for the layer-by-layer manufacture of a three-dimensional object by means of selective hardening at those sites of a layer of a building material that correspond to the cross-section of the object through the use of a laser, comprising a laser (1) and a focussing unit (6) for the focussing of the laser radiation,
characterized in that the laser (1) comprises a device (8) for changing the modal composition of the laser radiation.

2. Device according to claim 1, characterized in that the device (8) for changing the modal composition comprises at least one mode aperture (3).

3. Device according to claim 1 or 2, characterized by a unit for beam expansion (4).

4. Method for the layer-by-layer manufacture of a three-dimensional object by the application of laser radiation to the sites of a layer corresponding to the cross-section of the object, characterized in that the laser is operated during the manufacture with the modal composition being adjustable.

5. Method according to claim 4, characterized in that the modal composition is changed for the purpose of supplying a desired amount of energy.

6. Method according to claim 4 or 5, characterized in that the modal composition is changed to a lower order mode, preferably to the fundamental mode, depending on the site on the layer that is impacted by the laser radiation.

7. Method according to anyone of the claims 4 to 6, characterized in that the modal composition is limited to the fundamental mode in a marginal area of a partial area of a layer, said marginal area being impacted by the laser radiation, and in that the modal composition contains higher order modes in addition to the fundamental mode in an inner area of the partial area.

8. Method according to anyone of the claims 4 to 7, characterized in that the laser radiation is focussed before being impacted.

9. Method according to claim 8, characterized in that the laser radiation is focussed depending on its modal composition.

10. Method according to claim 9, characterized in that the laser radiation is focussed more strongly in a marginal area of a partial area of a layer, said marginal area being impacted by the laser radiation, than in an inner area of the partial area.

11. Method according to anyone of the claims 4 to 10, characterized in that the modal composition is changed depending on the rate at which the focussed beam is moved across the layer.
